(19) United States
(12) Patent Application Publication
(10) Pub. No.: US 2021/0164612 A1
(43) Pub. Date: Jun. 3, 2021

(54) Brake assembly for a pole

(71) Applicant: Goodcart Pty Ltd, Mona Vale (AU)

(72) Inventor: Douglas Rawson-Harris, Mona Vale (AU)

(73) Assignee: Goodcart Pty Ltd, Mona Bale (AU)

(21) Appl. No.: 17/105,941

(22) Filed: Nov. 27, 2020

(30) Foreign Application Priority Data
Nov. 28, 2019 (AU) 2019904503

(51) Int. Cl. F16M 13/02; F16D 59/00; F16D 63/00

(52) U.S. Cl. CPC F16M 13/022; F16D 2121/14; F16D 63/008; F16D 59/00

(57) ABSTRACT

The invention provides a brake assembly for a module. The module is mountable to a pole having a track. The brake assembly is connectable to the module and has two brake members configured to fit at least partly adjacent each other on the track. The brake assembly also has a biasing member for urging the brake members apart such that at least one brake member engages the track to resist falling of the module. A pole is also provided, having an elongate shaft with the track, the module and the brake assembly of the invention. A flexible rope is connectable to the brake assembly for moving the brake assembly along the track.

### CROSS-REFERENCE TO RELATED APPLICATION

The present invention claims priority to Australian Patent Application No. 2019904503 filed Nov. 28, 2019, which is incorporated by reference in its entirety.

### FIELD OF THE INVENTION

The present invention relates to poles suitable for street lighting, displaying banners or signage, conveying electricity, telecommunication boxes and other devices. The invention has been developed primarily for use with poles that are hollow and produced from aluminium, and will be described hereinafter by reference to this application. However, it will be appreciated that the invention may be applied to other types of poles of similar construction, including electricity poles or telegraph poles.

### BACKGROUND OF THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

In the field of elongated support structures and in particular street poles or lighting, there have been significant changes made in the manufacture and instalment of such street and outdoor lighting poles, due to architectural design, aesthetic demand and urban design. This has led to the development of poles that can mount a variety of items or modules, such as lighting, traffic control lights, CCTV, banners, signage, public warning signs or lights, telecommunication devices, environmental monitoring device, pedestrian management devices and electronic devices, especially in public areas.

The Applicant's Multipole™ and Multipole Solar™ products deliver an aesthetically pleasing all aluminium multi-function pole that can provide a flexible secure home for many of the services required in the streetscape. In addition the poles can be the basis for the provision of public amenities such as bike racks, bus shelters, water bubblers and seats. Among its many advantages are that the poles are provided with an extruded aluminium base section with a first cross-section shape and size, and a mast of second cross-section shape and size (preferably smaller than said first cross-section) connected to and supported by the mast. The lower supporting mast section is sometimes provided with flutes, reabsorbed channels or ribs. These ribs have multiple functionality including aesthetics, the ability to add accessories, etc. but they also serve the purpose of strengthening. As it will be understood by persons skilled in the art, previously constructed steel poles did not require such strengthening ribs since steel is stronger in a conventional tube. Aluminium on the other hand, can be extruded in quite complex cross-section which are both strong and light weight.

Generally, to install or mount items like luminaires, banners, signs, telecommunication boxes or other electronic devices to the pole, it is necessary for a worker in a cherry picker or other lift device to handle the item from above and fasten it to the pole in situ. This can be difficult to perform and there is a risk of the item being dropped, damaging itself or injuring a worker below. Moreover, the task is time consuming, inconvenient and inefficient, increasing installation costs in time and manpower. This problem also occurs when the item is to be removed or replaced.

To address these issues, mounting systems have been developed. One such system based on a flag pole, where the item to be mounted is installed from the ground using a cabling or rope system. The item is drawn upwards by a rope, cable, wire and the like into the desired position and the rope, cable, wire or the like is then secured to hold the mounted item in position on the pole. However, a risk with this mounting system is that in the event the rope or cable failure, either by becoming untied, frayed or cut, the mounted item will fall, causing damage to itself, people or structures beneath.

It is an object of the present invention to overcome or substantially ameliorate one or more of the disadvantages of prior art, or at least to provide a useful alternative. It is an object of the invention in at least one preferred form to provide a brake system for preventing or minimising the risk of mounted items falling from a pole due to failure of the mounting rope or cable, and hence any damage caused by the falling item.

### SUMMARY OF THE INVENTION

According to a first aspect, the present invention provides a brake assembly for a module mountable to a pole having an elongate shaft with at least one track, the brake assembly being connectable to the module and comprising at least two brake members configured to fit at least partly adjacent each other and a biasing member for urging the at least two brake members apart such that at least one brake member engages the at least one track to resist falling of the module.

According to a second aspect, the present invention provides a pole comprising an elongate shaft having at least one track, the brake assembly according to the first aspect of the invention, a module connectable to the brake assembly for mounting to the pole and a flexible rope connectable to the brake assembly for moving the brake assembly along the at least one track.

In some embodiments, the at least two brake members interlock with each other. In other embodiments, the at least two brake members comprise locking portions for mutual engagement with each other. In further embodiments, the locking portions of the at least two brake members each comprises a stop. In yet other embodiments, the locking portions of the at least two brake members have complementary shapes.

In some embodiments, the at least two brake members are each connectable to a flexible rope at one end. In other embodiments, the ends of the at least two brake members connectable to the flexible rope are opposite to each other.

In some embodiments, the at least two brake members are configured to fit at least partly adjacent each other on the at least one track. In other embodiments, on the at least one track the at least two brake members are configured to fit at least partly laterally adjacent each other on the at least one track.

In some embodiments, the biasing member urges the at least two brake members apart in a lateral direction to a longitudinal axis of the at least one track. In some embodiments, the biasing member urges the at least two brake members apart in at an oblique angle to a longitudinal axis of the at least one track.

In some embodiments, the biasing member comprises a spring.

In some embodiments, one or more of the at least two brake members have a cam portion to facilitate movement of the at least two brake members apart from each other. In other embodiments, the cam portion comprises a linear cam portion. In further embodiment, the linear cam portion takes the form of an inclined portion or ramp. In yet other embodiments, the at least two brake members have cam portions that are engageable with each other.

In some embodiments, one of the at least two brake members comprises an opening for receiving the biasing member. In other embodiments, the opening comprises a bore, cavity, recess or the like in the brake member.

In some embodiments, one of the at least two brake members is pivotable relative to the other of the at least two brake members.

In some embodiments, the brake assembly is slidable on the at least one track. In further embodiments, the brake assembly is configured to engage laterally extending ribs of the at least one track. In other embodiments, the brake assembly comprises one or more base members for engaging the at least one track.

In some embodiments, each brake member is connected to a base member. In other embodiments, at least one brake member is pivotally connected to the base member. In further embodiments, at least one brake member is fixedly connected to the base member.

Alternatively, in some embodiments, the at least two brake members are pivotably connected to each other. In other embodiments, a first brake member has an opening for receiving a fastener to pivotally connect the first brake member to a second brake member.

In some embodiments, the base member comprises an engagement portion for engaging the track. In other embodiments, the engagement portion comprises one or more flanges for engaging a rib of the track. In further embodiments, the engagement portion comprises two flanges defining a groove for receiving the retaining rib.

In some embodiments, the brake assembly comprises a mounting element for connecting the brake assembly to the module. In other embodiments, the mounting element is connected to the base members or the at least two brake members. In further embodiments, the mounting element comprises a mounting plate.

Alternatively, in some embodiments, a mounting element connects the brake assembly to the module. In other embodiments, the mounting element is slidable on the at least one track. In further embodiments, the mounting element comprises a mounting plate.

In some embodiments, there is a plurality of brake members.

In some embodiments, the mounting element comprises a bar for supporting the module on the pole. In other embodiments, the module comprises a bar for supporting a flag, banner, sign or other planar element. In further embodiments, the bar extends substantially orthogonal to the mounting element. In yet other embodiments, the bar extends at an oblique angle to the mounting element.

In some embodiments, the at least one track extends along the length of the elongate shaft from a first point to a second point, wherein the brake assembly is slidable along the at least one track between the first and second points.

In some embodiments, the at least one track is located in an interior surface of the elongate shaft. Preferably, the at least one track is recessed in the elongate shaft. In other embodiments, the at least two brake members are configured to fit at least partly adjacent each other within the at least one track and the biasing member urges the at least two brake members apart and into engagement with the sidewalls of the at least one track.

In other embodiments, the at least one track is located in an exterior or outer surface of the elongate shaft. In other embodiments, the biasing member urges the at least two brake members apart such that one brake member engages the at least one track and the other brake member engages the module or the mounting element.

In some embodiments of the second aspect, the flexible rope is connected to the brake assembly under tension such that the at least two brake members interlock with each other and, when the flexible rope loses tension, the biasing member urges the at least two brake members apart.

In some embodiments, the at least one track comprises a channel. In other embodiments, the at least one track comprises one or more retaining ribs extending laterally of the at least one track to retain the brake assembly, module or mounting element on the at least one track. In one preferred embodiment, the at least one track comprises a pair of retaining ribs extending inwardly of the at least one track. The retaining ribs may also provide additional structural support to the pole.

In some embodiments, there is a plurality of the tracks. In other embodiments, the elongate shaft may have a generally rectangular, square, circular, oval or other polygonal cross-sectional profile. In one particularly preferred embodiment, the elongate shaft has a generally rectangular or square cross-sectional profile and the tracks are located at the vertices of the rectangle or square.

In some embodiments, the elongate shaft is substantially hollow. In other embodiments, the elongate shaft is formed by extrusion. Preferably, the at least one track is integrally formed with the elongate shaft by extrusion. In an alternative embodiment, the at least one track may be formed separately and attached to the elongate shaft.

In some embodiments, the at least one track extends substantially along the entire length of the elongate shaft. In other embodiments, the at least one track extends from a base portion of the elongate shaft to the top of the elongate shaft.

In some embodiments, the first point is located adjacent at a base of the elongate shaft. In other embodiments, the first point is located a predetermined distance from the base of the elongate shaft.

In some embodiments, the second point is located adjacent or at the top of the elongate shaft. In other embodiments, the second point is located a second predetermined distance from the top of the elongate shaft.

In some embodiments, the module comprises a luminaire or other light fitting. In other embodiments, the module comprises a banner, sign, flag or planar element. In further embodiments, the module comprises a telecommunications box, traffic control, CCTV, one or more environmental sensors, an electronic module or other electrical device.

In some embodiments, the pole includes one or more solar panels. In further embodiments, the one or more solar panels comprise one or more batteries on its inner surface for storing electrical power generated by the one or more solar panels. In yet another embodiment, the elongate shaft comprises one or more cavities in the exterior surface for receiving the one or more solar panels. In some embodiments, the one or more cavities include a resilient member for spacing the one or more solar panels from the inner surface of the cavity. In other embodiments, the cavity may accommodate wiring and other electrical equipment for connecting the one or more solar panels to the module.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of the brake assembly according to an embodiment of the invention connected to a module;

FIG. 2 is a partial close up perspective view of the brake assembly of FIG. 1;

FIG. 3 is an exploded view of the brake assembly of FIG. 1;

FIG. 4 is a perspective view of a brake assembly of FIG. 1 installed on a pole;

FIG. 5 is a partial close up perspective view of the brake assembly of FIG. 4;

FIG. 6 is a partial front view of the pole of FIG. 4;

FIG. 7 is a cross-sectional view of the pole taken along line A-A of FIG. 6;

FIG. 8 is a cross-sectional view of the brake assembly of FIG. 7;

FIG. 9 is an exploded view of the brake assembly and pole of FIG. 1;

FIG. 10 is a side view of FIG. 9;

FIG. 11 is a perspective view of another embodiment of the invention;

FIG. 12 is a close-up perspective view of the brake assembly of FIG. 11;

FIG. 13 is another perspective view of the brake assembly of FIG. 11;

FIG. 14 is a further perspective view of the brake assembly of FIG. 11; and

FIG. 15 is yet another perspective view of the brake assembly of FIG. 11.

### PREFERRED EMBODIMENTS OF THE INVENTION

The present invention will now be described with reference to the following examples which should be considered in all respects as illustrative and non-restrictive. In the Figures, corresponding features within the same embodiment or common to different embodiments have been given the same reference numerals.

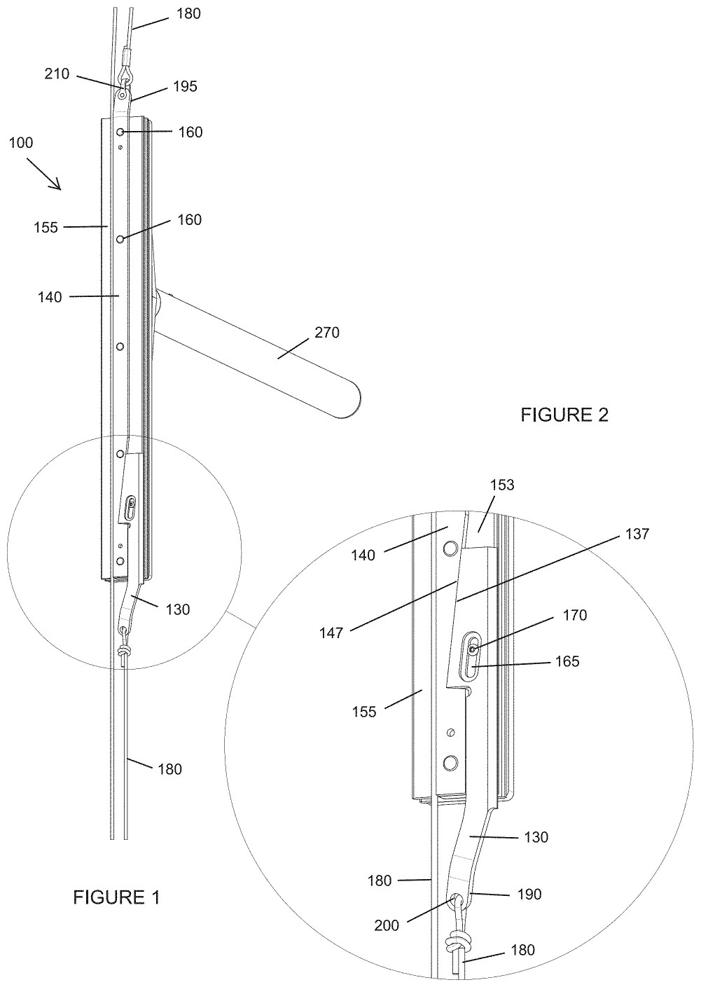

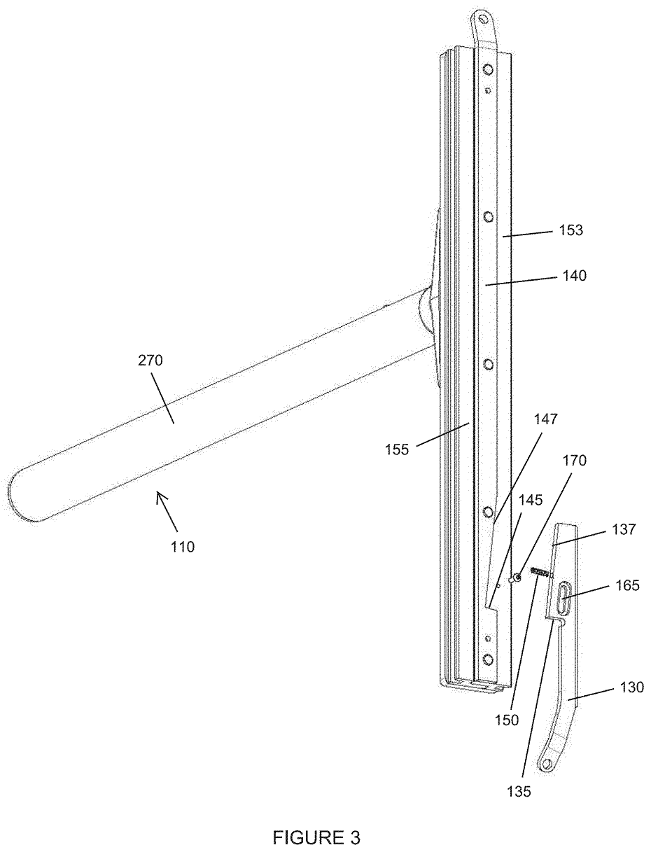

Referring to FIGS. 1 to 3, there is illustrated a brake assembly 100 according to one embodiment of the present invention for a module 110 mountable to a pole 115 having an elongate shaft 120 with a plurality of tracks 125. The brake assembly comprises at least two brake members 130, 140 configured to fit at least partly adjacent each other and a biasing member 150 (preferably in the form of a spring) for urging the brake members apart such that at least one brake member engages the track 125 to resist falling of the module 110.

The brake members 130, 140 are designed to detachably interlock with each other. To that end, the brake members 130, 140 each have locking portions for mutual engagement with each other. In this embodiment, the locking portions take the form of stops 135, 145 that abut each other when the brake members are adjacent each other on the track 125. In addition, the brake members each have a cam portion to facilitate movement apart from each other, preferably a linear cam portion. In this embodiment, the linear cam portions take the form of inclined portions or ramps 137, 147 that are engageable with each other. When the brake members 130, 140 are partly laterally adjacent to each other and interlocked, the ramps 137, 147 are in engagement with each other.

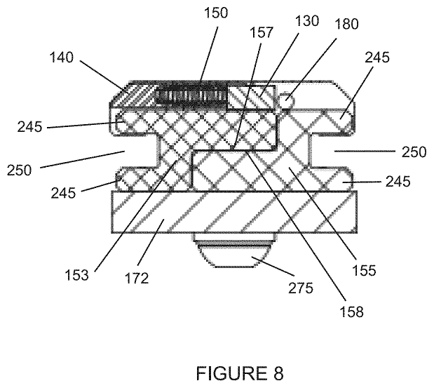

The fall assembly 100 further comprises two base members 153, 155 that are respectively connected to the brake members 130, 140. The base members 153, 155 enable the brake assembly 100 to engage and slide along the track 125. In this embodiment, the base members 153, 155 have engagement portions 157, 158 to mutually engage each other, as best shown in FIGS. 7 and 8. The brake member 130 is pivotally connected to the base member 153, while the brake member 140 is fixedly connected to the base member 155 by a plurality of fasteners 160, such as bolts, screws or nails, as best shown in FIG. 1. In other embodiments, the base members 153, 155 may be integrally formed as a single base member.

The brake member 130 in this embodiment has an opening for receiving a fastener to pivotally connect it to the base member 153. The opening takes the form of a slot 165, but it will be appreciated that in other embodiments, it may take other forms, such as a bore. Similarly, the fastener in this embodiment is a pin 170, but other embodiments may use other types of fasteners, such as bolts, screws or nails.

The brake assembly 100 also has a mounting element in the form of a mounting plate 172 for fixedly connecting the base members 153, 155, and hence the brake members 130, 140, together as a single unit. The mounting plate 172 also enables the module 110 to be removably attached to the brake assembly 100.

The brake member 130 also has an opening in the form of a bore 175 of receiving the biasing member 150. In other embodiments, the opening comprises a cavity, recess or the like in the brake member 130. The bore 175 is preferably arranged so that the biasing member applies a biasing force at an oblique angle to the longitudinal axes of the brake members 130, 140. This ensures that the spring 150 acts to force the brake members 130, 140 apart and cause a braking action between the brake assembly 100 and the track 125. It will be appreciated that the biasing member 150 can be arranged to be substantially orthogonal or perpendicular to the longitudinal axes of the brake members 130, 140.

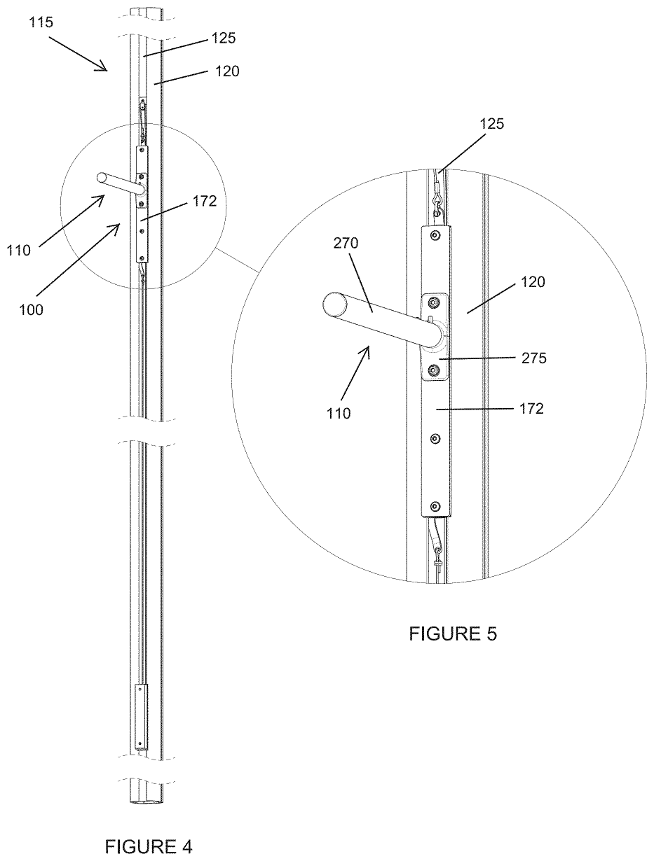

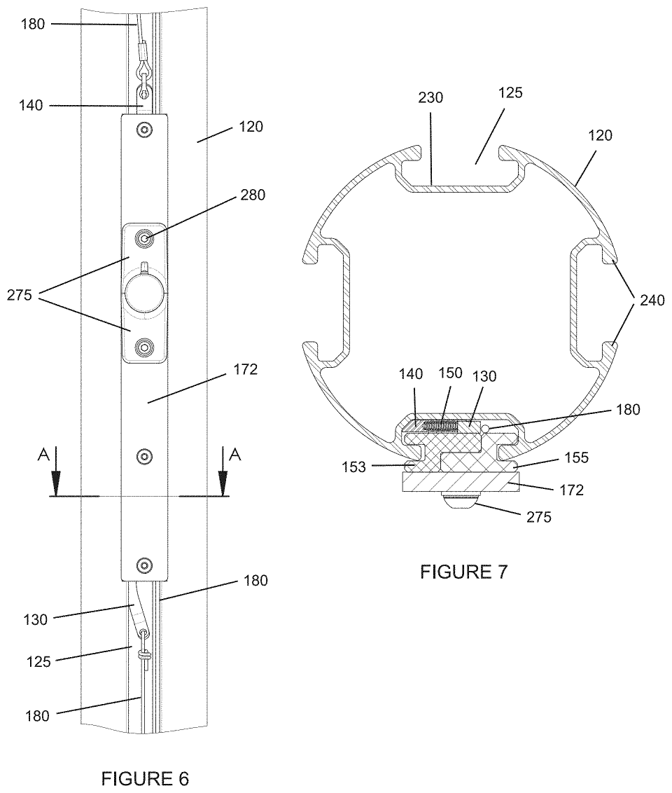

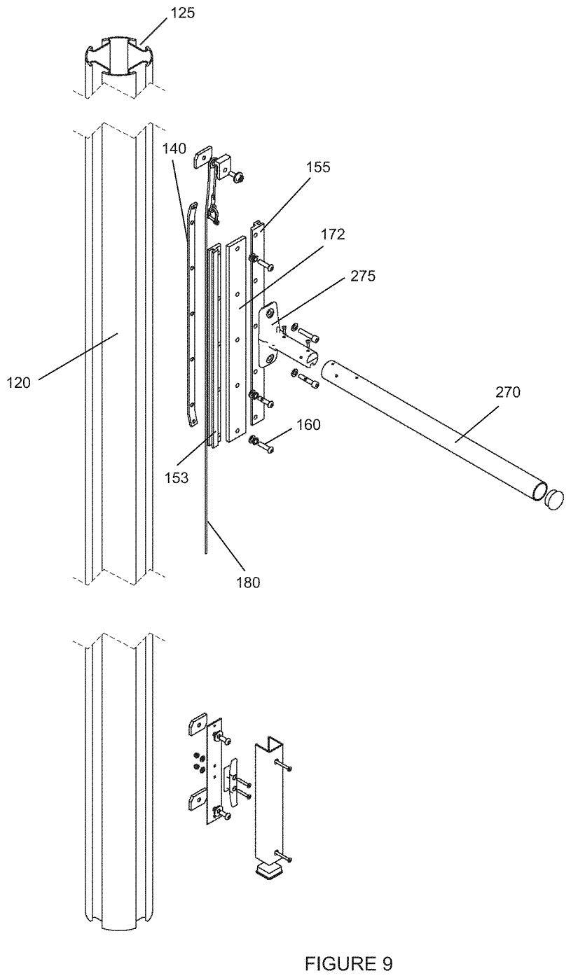

Referring to FIGS. 4 to 10, the brake assembly 100 is illustrated when installed on the track 125 of the pole 115. The pole 115 may be used as a street lighting pole, a telecommunications pole, pole supporting a banner or sign, a mast or the like.

The brake members 130, 140 are each connectable to a flexible rope 180 at respective ends 190, 195. As best shown in FIG. 1, the respective ends 190, 195 of the brake members 130, 140 are opposite to each other. The flexible rope 180 may be connected by either tying a loop around an eyehole (such as the eyehole 200 shown at end 190 of brake member 130) or a ring (such as the ring 210 shown at end 195 of brake member 140). It will be appreciated that the flexible rope 180 may the connected to the ends 190, 195 of the brake members 130, 140 by other fastening arrangements.

In this embodiment, the track 125 takes the form of a longitudinal channel running parallel to the longitudinal axis of the elongate shaft 120. As best shown in FIG. 7, in this embodiment, the tracks 125 are recessed in the elongate shaft 120 so as to be located in an interior surface 230 and extend along the length of the elongate shaft from a base portion (not shown) of the pole 115 to a top portion (not shown) of the pole.

In addition, the track 125 has one or more retaining ribs 240 extending laterally of the at least one track to retain the module on the track. In this embodiment, there are a pair of retaining ribs 240 extending inwardly of the track 125, as best shown in FIG. 7. The retaining ribs 240 may also provide additional structural support to the pole 115.

The brake members 130, 140 are configured to fit at least partly adjacent each other on the track 125, preferably laterally adjacent each other. In other words, the brake members 130, 140 are partly side by side on the track 125. In other embodiments, the brake members 130, 140 may be fully aligned side by side on the track 125. Likewise, the base members 153, 155 are also configured to fit laterally adjacent each other in the track 125, as best shown in FIG. 7. The base members 153, 155 each have engagement portions in the form of flanges 245 that define grooves 250 for receiving the retaining ribs 240 to ensure that the brake assembly 100 is securely held in the track 125. The brake assembly 100 is thus located within the track 125 so that it is slidable along the track.

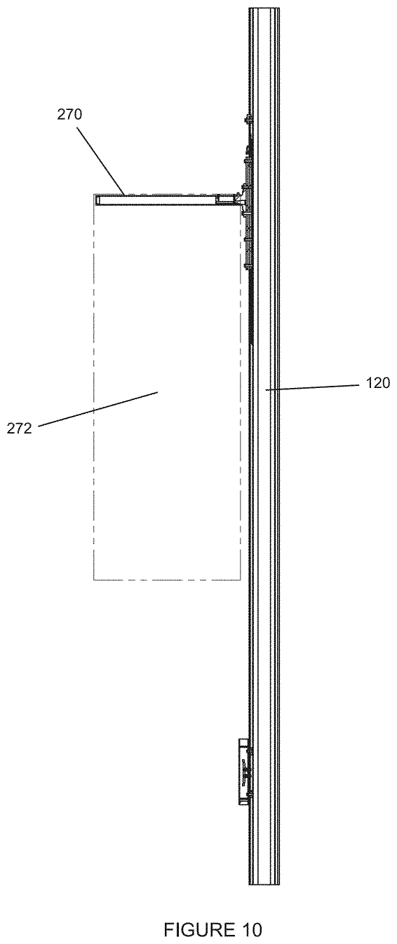

In this embodiment, the module 110 comprises a bar 270 for supporting a flag, sign or banner 272 (as indicated by dotted lines in FIG. 10) from the pole 115. The module 110 is removably fixed to the mounting plate 172 by a pair of cover plates 275 and fasteners 280. This enables the module 110 to be easily installed on the pole 115 by way of its removable attachment to the brake assembly 100, as discussed below.

To install the module 110 on the pole 115, the module is removably attached to the mounting plate 172 of the brake assembly 100, as discussed above. The brake assembly 100 is then inserted into a lower end of the track 125 near the base of the pole 115, so that the grooves 250 of the flanges 245 of base members 153, 155 receive the retaining ribs 240 of the track. The flexible rope 180 may be attached to the ends 190, 195 of the brake members 130, 140 of the brake assembly 100 before or after the brake assembly is slid into the track 125. The brake assembly 100, now carrying the module 110, is then pulled up along the track 125 by the flexible rope 180 to a desired position on the pole 115. As the module 110 travels along a path defined by the track 125 and held on the track by the retaining ribs 240, there is no risk of the module 110 or the brake assembly 100 deviating out of position as it moves along the pole 115. The flexible rope 180 is then secured or tied to retain the brake assembly 100 and mounted module 110 in its desired position on the pole 115. To replace or remove the module 110, the process is performed in reverse; the flexible rope 180 is untied and the brake assembly 100 (and hence module 110) is lowered along the track 125.

It should be noted that as the brake assembly 100 is hauled up the track 125, the flexible rope 180 at the end 195 of brake member 140 applies an upward force that causes the stop 145 to engage the stop 135 on the brake member 130. This causes the brake members 130, 140 to align partly adjacent each other and to interlock together, which permits the brake assembly 100 to move smoothly along the track 125. This upward force also overcomes the biasing action of the biasing member 150 to urge the brake members 130, 140 apart. The interlocking of the brake members 130, 140 remains so long as the flexible rope stays under tension, including when the flexible rope 180 is tied to secure the brake assembly 100 and module 110 into position on the pole 115.

In the event of a failure event occurring, such as the flexible rope 180 breaking (suddenly or due to fraying) or becoming untied, this causes a loss in tension in the flexible rope. This causes the brake assembly 100, including the module 110, to begin to fall. However, the brake assembly 100 and module 110 are still retained in the track 125 and so the path of the fall is limited to the track. In response to this loss of tension, the biasing member 150 is able to exert a lateral force to move the brake members 130, 140 apart from each other in a generally lateral direction to the track 125, at an oblique angle to the longitudinal axes of the brake members 130, 140, as well as the longitudinal axis of the track. As the biasing member 150 is located within the bore 175 of the brake member 140, it tends to move the brake member 130. However, the pin 170 restrains the range of movement of the brake member 130, causing it to pivot outwards and away from the brake member 140 into engagement with the sidewall of the track 125. This separation of the brake members 130, 140 is facilitated by the ramps 135, 145, which cause the brake members to progressively slide apart in a lateral direction to the track 125. As a consequence of this separating action, the brake members 130, 140 engage the sidewalls of the track 125, resisting the falling action of the brake assembly 100 and module 110, effectively acting as a brake. Thus, the brake assembly 100 and module 110 will either come to a complete stop further down the track 125 or at least slow down the fall to a safe speed, limiting any damage to people underneath and/or the module 110 when striking the ground.

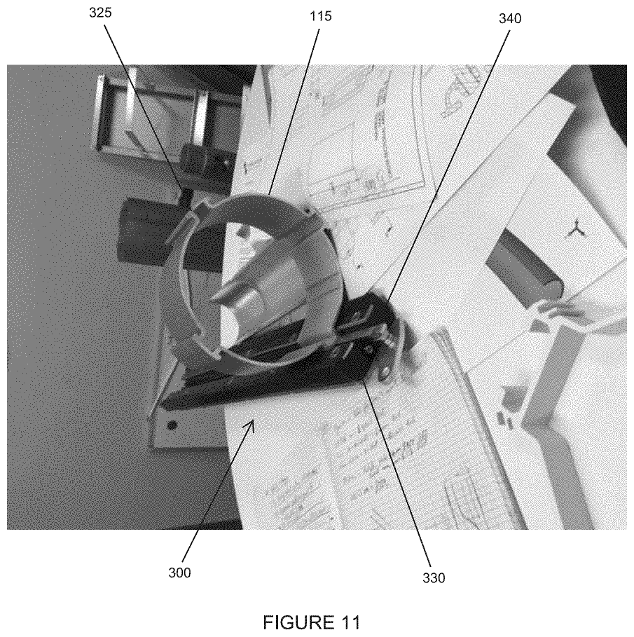

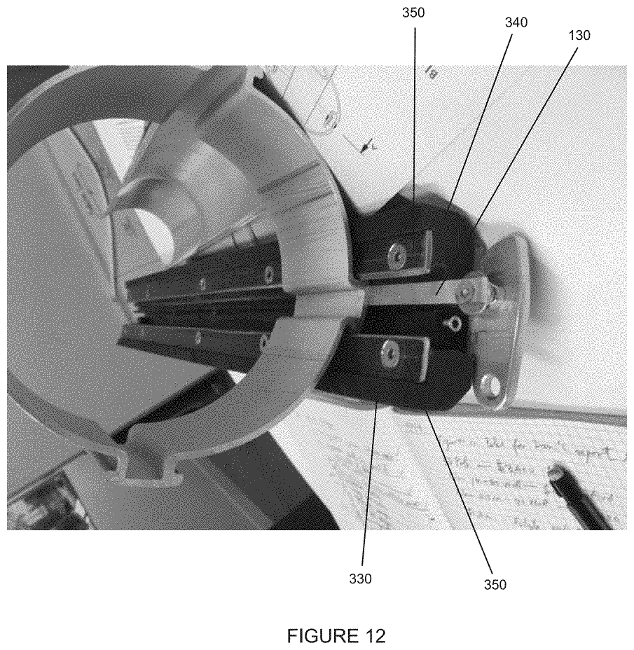

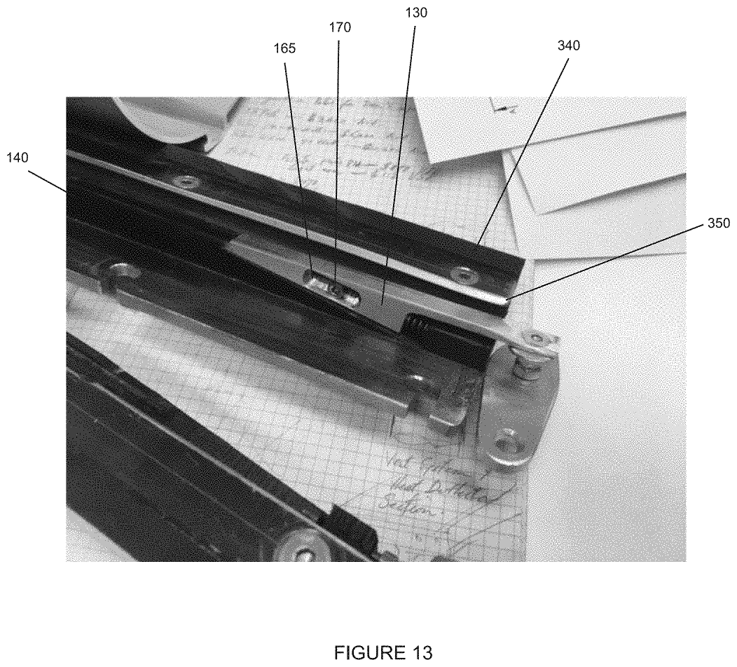

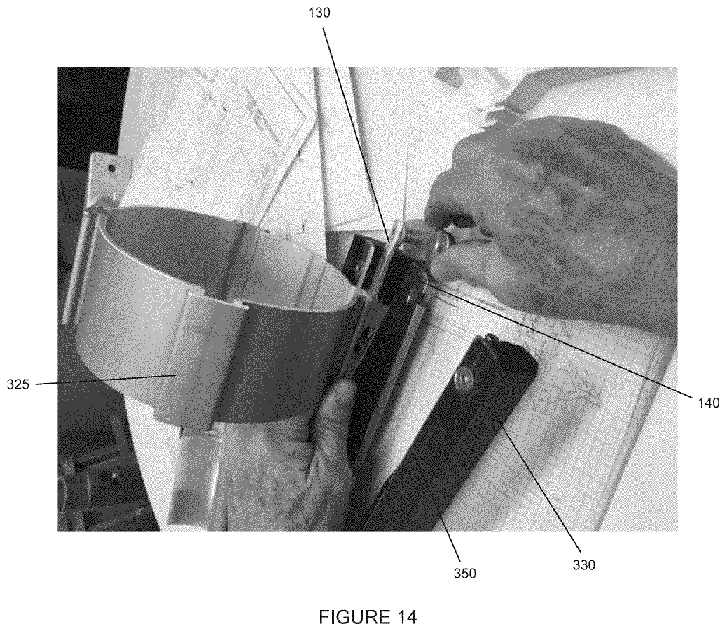

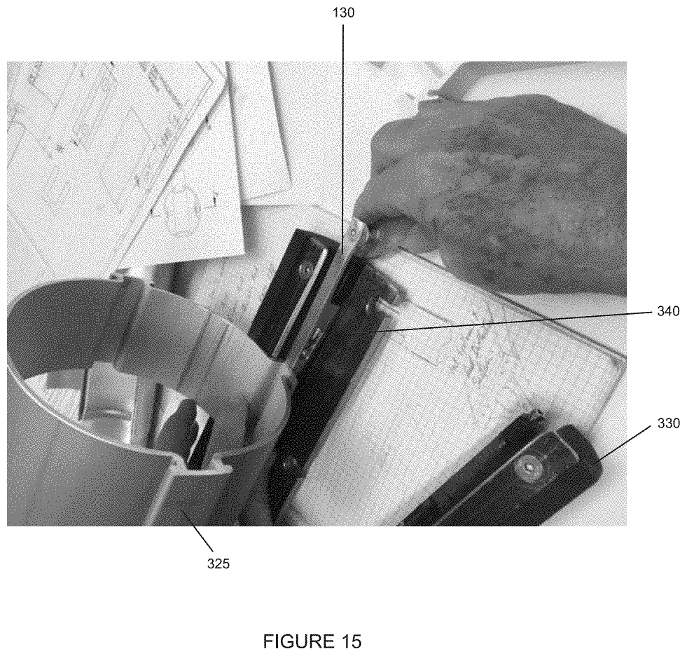

Referring to FIGS. 11 to 15, another embodiment of the invention is illustrated, where the brake assembly 300 is adapted to slide on a pole 115 that has a track 325 located on an exterior or outer surface of the elongate shaft 120 instead of being recessed within an interior surface. The track 325 in this instance may be extruded with the elongate shaft 120 or be attached separately. In this embodiment, the brake assembly 300 is substantially the same as the brake assembly 100, comprising brake members 130, 140 but is adapted to fit on the external track 325. This is achieved by providing base members 330, 340 with inwardly extending flanges 350 that engage outwardly directed retaining ribs 360 of the track 325. That is, instead of the base members 153, 155 of the brake assembly 100 fitting within the track 125, the brake assembly 300 is mounted on the track 325 by having the base members 330, 340 surround the ribs 350 via the inwardly extending flanges 350 to grip the track 325.

Also, the brake members 130, 140 are connected to the base member 330, the brake member 130 being pivotally connected to the base member 330 by a pin 170 secured to a slot 165 in the brake member 130.

Moreover, the brake assembly 300 is also arranged so that the brake members 130, 140 lie on and adjacent the track 325, orthogonal to the orientation of the brake assembly 100. This arrangement for the brake assembly 300 means that biasing member 150 can urge the brake members 130, 140 apart so that the brake member 130 engages the track 325 while the brake member 140 engages the base member 340, creating the same braking action as described above to resist falling of the brake assembly 300 and the attached module 110. In all other respects, the brake assembly 300 operates in the same way as the brake assembly 100.

While the embodiments of the invention describe the biasing member 150 being generally positioned in the bore 175 to urge the brake members at an oblique angle in a generally lateral direction to the track 125, 325, it will be appreciated that in other embodiments, the biasing member 150 may urge the brake members 130, 140 in a substantially orthogonal or perpendicular direction to the longitudinal axis of the track 125, 325. In both cases, the separating action creates a braking action to resist the falling movement of the brake assembly 100, 300 and module 110.

Similarly, the brake assembly 100, 300 may be configured to slide on the track 125, 325 without necessarily requiring the base members 153, 155. Also, the brake assembly 100 may use other removable connecting elements to secure the brake assembly 100 to the track 125 other than the flanges 245. Furthermore, the brake assembly 100, 300 may have multiple brake members 130, 140. For example, a second brake member of the same type as the brake member 130 may be pivotally connected to the base member 153 or 155 to provide a fail-safe in the event that the brake member 130 fails to operate.

In alternative embodiments, the mounting element or plate 172 may be a separate component to the brake assembly 100 or even be part of the module 110. The mounting element may also be a block, boss or other mounting member and need not be a plate. Similarly, the bar 270 may be part of the mounting element 172 or the module 110. The bar 270 may also extend at an oblique angle to the mounting element or plate 172 or the pole 115, as desired.

As shown in FIG. 7, the elongate shaft 120 is substantially hollow and the tracks 125 are integrally formed with the elongate shaft by extrusion. It will be appreciated that in other embodiments, the track 125 may be formed separately and attached to the elongate shaft 120. In addition, the elongate shaft 120 has a generally circular cross-sectional profile and the tracks 125 are located at equidistant locations on the circumference of the circle. Again, it will be appreciated that the elongate shaft 120 may have other cross-sectional profiles, such as rectangular, square, oval, hexagonal, pentagonal or other polygonal cross-sectional profile. Where the cross-sectional profile is one with vertices, it is preferred that the tracks are located at those vertices to remove sharp edges from the pole.

In other embodiments, the length of the track 125 may vary as desired. For example, the track 125 may extend substantially along the entire length of the elongate shaft towards the bottom of the pole. Similarly, the track 125 may extend along only a portion of the elongate shaft. For example, one end of the track 125 may be located at a point a predetermined distance from the base portion or bottom of the elongate shaft 120. Likewise, the other end of the track 125 may be located predetermined distance from the top of the elongate shaft 120.

In other embodiments, a removable end cap may be provided on one or both ends of the track 125 to secure the brake assembly 100 (and hence module 110) on the pole 115. The removable end cap also closes off the track 125 from the egress of contaminants.

While the embodiment has been described in relation to the module 110 comprising a bar 275 for supporting a flag, sign or banner or other planar element, persons skilled in the art will recognise that the module can be any other type of item that may be used in conjunction with a street pole. For example, the module can be a luminaire or other type of light fitting, telecommunications box, traffic control, CCTV, an electronic module or other electrical devices like environmental sensors. The module 110 may either replace the bar 275 with or add other supporting structures for telecommunication boxes, traffic control, CCTV, an electronic module or other electrical devices.

In the described embodiment, the pole 115 may also have a plurality of solar panels for providing power to the module 110 where it takes the form of a luminaire or other lighting, telecommunications box, traffic control, CCTV, one or more environmental sensors, an electronic module or other electrical device, as well as and any other electrical equipment housed within the pole. The solar panels may batteries on its inner surface for storing electrical power generated by the one or more solar panels. In general, the solar panels are fitted to the outer surface of the elongate shaft, which has cavities for receiving the solar panels. A resilient member in the form of a pre-loaded spring is located within each cavity to space and support each solar panel from the inner surface of the cavity. The cavities may accommodate wiring and other electrical equipment for connecting the solar panels to the module 110 or providing power to other devices within or attached to the pole 115.

It will further be appreciated that any of the features in the preferred embodiments of the invention can be combined together and are not necessarily applied in isolation from each other. For example, the bar 270 of the module 110 may extend at an oblique angle to the pole 115 while the brake assembly 100, 300 has an integrated base member instead of separate base members 153, 155. Similar combinations of two or more features from the above described embodiments or preferred forms of the invention can be readily made by one skilled in the art.

Since the brake assembly 100, 300 is connected to the track 125, 325, module 110 and the flexible rope 180 holding up the module 110, it can respond when a fall event occurs to brake or resist falling of the module. Thus, it avoids the risk of injury to workers or bystanders, and damage to the module, that could by caused by the module 110 falling from a height during installation or when the flexible rope 180b breaks or is suddenly released (such as becoming untied) when the module is in position on the pole. These advantages also extend to situations where the module is removed and/or replaced, reducing maintenance time and costs. Hence, the present invention provides the benefits of improved safety during installation or removal of modules 110 to and from the pole 115, as well as when the module is in position on the pole. In addition, by having the brake assembly 100, 300 engageable to the track 125, 325, it minimises the risk of detachment and thus damage or injury caused by a falling module.

Although the invention has been described with reference to specific examples, it will be appreciated by those skilled in the art that the invention may be embodied in many other forms.

1. A brake assembly for a module mountable to a pole having an elongate shaft with at least one track, the brake assembly being connectable to the module and comprising at least two brake members configured to fit at least partly adjacent each other on the at least one track and a biasing member for urging the at least two brake members apart such that at least one brake member engages the track to resist falling of the module.

2. The brake assembly of claim 1, wherein the brake members interlock with each other.

3. The brake assembly of claim 2, wherein the brake members comprise locking portions for mutual engagement with each other.

4. The brake assembly of claim 3, wherein the locking portion of a first brake member comprises a stop and the locking portion of a second brake member comprises a corresponding stop.

5. The brake assembly of claim 1, wherein the brake members are each connectable to a flexible rope at one end, wherein the ends of the brake members connectable to the flexible rope are opposite to each other when located on the at least one track.

6. The brake assembly of claim 1, wherein the brake members are configured to fit at least partly laterally adjacent each other.

7. The brake assembly of claim 1, wherein the biasing member urges the at least two brake members apart in a lateral direction to a longitudinal axis of the at least one track.

8. The brake assembly of claim 1, wherein the biasing member urges the at least two brake members apart in at an oblique angle to a longitudinal axis of the at least one track.

9. The brake assembly of claim 1, wherein one or more of the at least two brake members have a cam portion to facilitate movement of the at least two brake members apart from each other.

10. The brake assembly of claim 9, wherein the cam portion comprises a linear cam portion, an inclined portion or ramp.

11. The brake assembly of claim 1, wherein one of the at least two brake members is pivotable relative to the other of the at least two brake members.

12. The brake assembly of claim 1, wherein the brake assembly comprises one or more engagement portions for engaging laterally extending ribs of the at least one track.

13. The brake assembly of claim 12, wherein the brake assembly comprises one or more base members for engaging the at least one track, wherein each brake member is connected to a base member and the one or more base members each comprises an engagement portion for engaging the track.

14. The brake assembly of claim 13, wherein at least one brake member is pivotally connected to the base member.

15. The brake assembly of claim 12, wherein at least one engagement portion comprises one or more flanges for engaging a laterally extending rib of the at least one track.

16. A pole comprising an elongate shaft having at least one track, the brake assembly of claim 1, the module connectable to the brake assembly for mounting to the pole and a flexible rope connectable to the brake assembly for moving the brake assembly along the at least one track.

17. The pole of claim 16, wherein the at least one track is located in an interior surface of the elongate shaft and the at least two brake members are configured to fit at least partly adjacent each other within the at least one track and the biasing member urges the at least two brake members apart and into engagement with the sidewalls of the at least one track.

18. The pole of claim 16, wherein the at least one track is located in an exterior or outer surface of the elongate shaft and wherein the biasing member urges the at least two brake members apart such that one brake member engages the at least one track and the other brake member engages the module.

19. The pole of claim 16, wherein the flexible rope is connected to the brake assembly under tension such that the at least two brake members interlock with each other and, when the flexible rope loses tension, the biasing member urges the at least two brake members apart.

20. The pole of claim 16, wherein the module comprises a luminaire, a light fitting, a banner, a flag, a sign, a planar element, a telecommunications box, a traffic control device, a CCTV, one or more environmental sensors, an electronic module or an electrical device.
